(19) United States
(12) Patent Application Publication
(10) Pub. No.: US 2007/0226432 A1
(43) Pub. Date: Sep. 27, 2007

(54) Devices, systems and methods for creating and managing media clips

(76) Inventor: Jeffrey A. Rix, Wexford, PA (US)

Correspondence Address: BARTONY & HARE, LLP, 1806 FRICK BUILDING, 437 GRANT STREET, PITTSBURGH, PA, 15219-6101, US

(21) Appl. No.: 11/654,785

(22) Filed: Jan. 18, 2007

Related U.S. Application Data
(60) Provisional application No. 60/759,698, filed on Jan. 18, 2006.

(51) Int. Cl. G06F 13/00

(52) U.S. Cl. 711/154

(57) ABSTRACT

A system for presenting media streams includes: a memory system having stored therein data of a plurality media presentations; a communication network providing for communication between the memory system and at least one computer; and data for a user interface stored on the memory system. The interface includes an input mechanism to permit a user of the at least one computer to select from any of the plurality of media presentations and a clip identification system adapted to receive input regarding a starting point for at least one clip of the media presentation and input regarding a stopping point of the clip of the media presentation. The clip corresponds to a portion of the media presentation stream beginning at the starting point and ending at the stopping point. The clip identification system is adapted to create a clip identifier for the clip including the starting point and the stopping point. Activation of the clip identifier by the user causes the computer to receive a stream of data from the memory system corresponding to the clip.

### CROSS-REFERENCE TO RELATED APPLICATION

This application claims benefit of U.S. Provisional Patent Application No. 60/759,698, filed Jan. 18, 2006, the disclosure of which is incorporated herein by reference.

### BACKGROUND OF THE INVENTION

The present invention relates generally to devices, systems and methods for creating and managing media clips, and, particularly, to devices, systems and methods for creating and managing one or more digital video clips.

In recent years, more and more media presentations (for example, audio and/or video presentations) have been made available in digital format. Many such media presentations (for example, movies, sport events, songs, educational lectures etc.) are made available via the Internet for downloading and/or for streaming.

Streaming refers generally to a technique for transferring data such that it can be processed as a steady and continuous stream. Streaming technologies are increasingly important as many Internet users do not have sufficiently fast access to download large media/multimedia files quickly. Via streaming, a client browser or plug-in can begin to present the data to the user before the entire file has been transmitted. In general, the client side (receiving the data) collects the data and provides it as a steady stream to a software application (for example, WINDOWS MEDIA PLAYER available from Microsoft of Redmond, Wash., REALPLAYER available from RealNetworks, Inc. of Seattle, Wash. or QUICKTIME available from Apple of Cupertino, Calif.) that processes the data and converts it to sound/audio and/or pictures/video. If the streaming client receives the data more quickly than required, the excess data are saved in a buffer. If the client does not receive the data quickly enough, however, the presentation of the data will not be smooth. The data for the media presentation is typically not saved to the client computer in the case of streaming.

In the case of downloading of media presentation, a copy of a media data file including the data for the media presentation is saved to the client computer from, for example, an online service, a bulletin board service, or a network file server. The saved media data file can then be presented via a software application such as WINDOWS MEDIA PLAYER, REALPLAYER or QUICKTIME.

In certain situations, it is desirable for a user to play only a portion of a presentation corresponding to particular media data file. Such a portion of a media presentation is referred to herein as a “clip”. Moreover, it can be desirable for the user to play the same clip multiple times. Currently, there are no devices, systems or methods that facilitate the creation and management of such clips of either streamed or downloaded media presentations.

It is thus desirable to develop devices, systems and methods for creating and managing media clips, and, particularly, to develop devices, systems and methods for creating and managing one or more digital video clips.

### SUMMARY OF THE INVENTION

In one aspect, the present invention provides a system including: a memory system having stored therein at least one file executable to output a media presentation that plays over a period of time and at least one computer including at least one processor and at least one memory. The memory of the computer has a media program stored therein that is executable by the processor of the computer to receive data of the at least one file stored in the memory to present the media presentation to a user. The system also includes a communication system providing communication between the computer and the memory system and a clip creation system adapted to receive input regarding a starting point for at least one clip of the media presentation and input regarding a stopping point of the clip of the media presentation. The clip corresponds to a portion of the media presentation beginning at the starting point and ending at the stopping point. The clip creation system is adapted to create a clip identifier for the clip so that upon activation of the clip identifier by a user, the media program receives data from the file and presents the clip. The starting and stopping points can, for example, be modified by the user.

The system can further include a composite media presentation creation system including a mechanism to create a composite identifier for the composite media presentation in which a plurality of clips are grouped and associated with the plurality of clip identifiers. Activation of the composite identifier causes presentation of the composite media presentation in which each of the plurality of clips is presented in series. The plurality of clip identifiers can be grouped in the composite identifier in a defined order such that activation of the composite identifier causes presentation of the plurality of clips in the defined order. In one embodiment, the memory system has stored therein a plurality of files. Each of the plurality of files includes data of the media presentation corresponding to that file. Each of the media presentations plays over a period of time upon execution of the corresponding file. At least two of the plurality of clips can, for example, correspond to different files.

The clip creation system can include a user interface that includes an output mechanism to present media presentations to a user and an input mechanism to define the starting point of the at least one clip upon activation of the input mechanism at the starting point during output of the media presentation. The media presentation is presented via the output mechanism upon receipt of data of the computer file corresponding to the media presentation by the media program. The user interface can further include an input mechanism to define the stopping point upon activation of the input mechanism at the stopping point during output of the media presentation.

In another aspect, the present invention provides a clip creation system including a clip creation program adapted to receive input regarding a starting point for at F least one clip of a media presentation that is presentable upon receipt of data from a media file stored in a memory. The clip creation program includes an input mechanism to define a starting point of the clip of the media presentation and an input mechanism defining a stopping point of the clip of the media presentation. The clip corresponds to a portion of the media presentation beginning at the starting point and ending at the stopping point. The clip creation system is adapted to create a clip designation for the clip so that upon activation of the clip designation by a user the media program received data from the media file and presents the clip.

In another aspect, the present invention provides a method for creating clips including the steps: providing input for a starting point of a clip, the clip corresponding to a portion of at least one media presentation that is presentable upon receipt of data of a computer file corresponding to the media presentation by a media program, the clip beginning at the starting point and ending at a stopping point; providing input for the stopping point of the clip; and creating a clip designation comprising the starting point and the stopping point that, when activated by a user, causes the media program received data of the file and present the clip.

In a further aspect, the present invention provided a clip presentation system including a user interface including an output mechanism to present media presentations to a user and an input mechanism to define a starting point of a clip upon activation of the input mechanism at the starting point during output of a media presentation. The media presentation is presented via the output mechanism upon receipt of data of a computer file corresponding to the media presentation by a media program. The clip corresponds to a portion of the media presentation that is presentable upon execution of a computer file corresponding to the media presentation by a media program. The clip begins at the starting point and ends at a stopping point. The user interface further includes an input mechanism to define the stopping point upon activation of the input mechanism at the stopping point during output of a media presentation. The clip can, for example, be presented upon activation of a designator that, when activated, causes the media program to access data of the computer file and present the clip.

In another aspect, the present invention provides a method for creating a composite media presentation including a plurality of clips including the step: creating a plurality of clip identifiers, each of the clip identifiers comprising a starting point identifier for a corresponding one of the clips and a stopping point identifier for the one of the clips; storing the clip identifiers; and creating a composite identifier for the composite media presentation by grouping the plurality of clip identifiers and associating the plurality of clip identifiers with the composite identifier, activation of the composite identifier causes presentation of the composite media presentation in which each of the plurality of clips is presented in series.

The plurality of clip identifiers can, for example, be grouped in the composite identifier in a defined order such that activation of the composite identifier causes presentation of the plurality of clips in the defined order. Activation of the composite identifier can, for example, cause each of the plurality of clip identifiers to access data of a corresponding computer file storing data of a corresponding media presentation.

In another aspect, the present invention provides a media system including a database including a plurality of media presentations that play over a period of time and a communication portal adapted to provide communicative connection between the database and a computer. The computer includes at least one processor and at least one memory in communication with the database. The memory has stored therein a media computer program executable to present at least one of the media presentations upon receiving a stream of data from the database. The computer further includes a user interface comprising an output mechanism to present media presentations to a user, an input mechanism to define a starting point of a clip upon activation of the input mechanism at the starting point during output of the media presentation, and an input mechanism to define a stopping point upon activation of the input mechanism at the stopping point during output of the media presentation. The clip corresponds to a portion of the media presentation beginning at the starting point and ending at the stopping point.

In a further aspect, the present invention provides a system for presenting media streams including a memory system having stored therein data of at least one media presentation that is presentable over a period of time and at least one computer comprising at least one processor and at least one memory. The memory of the computer has a media program stored therein that is executable by the processor of the computer to receive a stream of data of the media presentation to present the media presentation to a user. The system further includes a communication system providing communication between the computer and the memory system and a clip identification system adapted to receive input regarding a starting point for at least one clip of the media presentation and input regarding a stopping F point of the clip of the media presentation. The clip corresponds to a portion of the media presentation stream beginning at the starting point and ending at the stopping point. The clip identification system is adapted to create a clip identifier for the clip comprising the starting point and the stopping point. Activation of the clip identifier by a user causes the computer to receive a stream of data corresponding to the clip.

In still a further aspect, the present invention provides a system for presenting media streams including a memory system having stored therein data of a plurality media presentations and at least one computer including at least one processor and at least one memory. The memory of the computer has a media program stored therein that is executable by the processor of the computer to received data from the memory and to present the media presentations. The system further includes a communication system providing communication between the computer and the memory and a user interface including an input mechanism to permit the user to select from any of the plurality of media presentations, an output mechanism to present the selected media presentation to the user as data arrives to the computer from the memory system via the communication system. The system also includes a clip identification system adapted to receive input regarding a starting point for at least one clip of the media presentation and input regarding a stopping point of the clip of the media presentation. The clip corresponds to a portion of the media presentation stream beginning at the starting point and ending at the stopping point. The clip identification system is adapted to create a clip identifier for the clip including the starting point and the stopping point. activation of the clip identifier by a user causes the computer to receive a stream of data from the memory system corresponding to the clip.

In another aspect, the present invention provides a method for presenting media streams including: providing data of a plurality of media presentations, each of which is presentable over a period of time, in a memory system accessible by at least one computer in communicative connection with the memory system; transmitting a stream of data of at least one of the media presentations to the at least one computer; a media program stored in at least one memory of the computer presenting the media presentations to a user as the stream of data is received; providing an input mechanism for identifying a starting point of at least one clip; providing an input mechanism for identifying a stopping point of the at least one clip, the at least one clip corresponding to a portion of the at least one media presentation, the at least one clip beginning at the starting point and ending at the stopping point; creating a clip identifier comprising the starting point and the stopping point of the at least one clip, activation of the clip identifier causing transmittal of a stream of data to the computer from the memory system corresponding to the at least one clip so that the at least one clip is presented via the media program; and storing the clip identifier on the memory system.

The method can further include creating a plurality of clip identifiers, wherein each clip identifier includes the starting point and the stopping point for a corresponding clip. Activation of one of the plurality of clip identifiers causes transmittal of a stream of data to the computer from the memory system corresponding to the corresponding clip so that the corresponding clip is presented via the media program. The method can also include the step of storing the plurality of clip identifiers on the memory system.

The method can also include the steps of: creating a composite clip identifier for a composite media presentation by grouping at least two of the plurality of clip identifiers and associating the plurality of clip identifiers with the composite clip identifier, activation of the composite clip identifier causes presentation of the composite media presentation in which each of the plurality of clips is presented in series; and storing the composite clip identifiers on the memory system.

In one embodiment, the method further includes: creating a list of all clip identifiers created by the user and stored on the memory system; and saving the list on the memory system. The method can further include permitting access to at least a portion of the list by another user so that the another user can activate at least one of the clip identifiers created by the user, causing transmittal of a stream of data to a computer of the another user from the memory system so that the corresponding clip is presented via the media program stored on the computer of the another user. The user can, for example, be permitted to choose whether each of the clip identifiers created by the user is available to the another user.

The method can also include the steps of: creating a plurality of clip identifiers of the user, each clip identifier comprising the starting point and the stopping point for a corresponding clip, activation of one of the plurality of clip identifiers causing transmittal of a stream of data from the memory system corresponding to the corresponding clip so that the corresponding clip is presentable via the media program; storing the plurality of clip identifiers on the memory system; and listing the plurality of clip identifiers on the list. The method can further include: creating at least one composite clip identifier of the user for a composite media presentation by the user grouping at least two of the plurality of clip identifiers and thereby associating the plurality of clip identifiers with the composite clip identifier, activation of the at least one composite clip identifier causing transmittal of a stream of data from the memory system corresponding to a presentation of the composite media presentation in which each of the plurality of clips is presented in series; storing the at least one composite clip identifier on the memory system; listing the at least one composite clip identifier on the list; and permitting access to at least a portion of the list by another user so that the another user can activate at least one of the clip identifiers and the at least one composite clip identifier created by the user, causing transmittal of a stream of data to a computer of the another user from the memory system so that the corresponding clip or the corresponding composite presentation is presented via a media program stored on the computer of the another user.

In still another aspect, the present invention provides a system for presenting media streams including: a memory system having stored therein data of a plurality media presentations; a communication network providing for communication between the memory system and at least one computer; and data for a user interface stored on the memory system. The interface includes an input mechanism to permit a user of the at least one computer to select from any of the plurality of media presentations and a clip identification system adapted to receive input regarding a starting point for at least one clip of the media presentation and input regarding a stopping point of the clip of the media presentation. The clip corresponds to a portion of the media presentation stream beginning at the starting point and ending at the stopping point. The clip identification system is adapted to create a clip identifier for the clip including the starting point and the stopping point. Activation of the clip identifier by the user causes the computer to receive a stream of data from the memory system corresponding to the clip.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates an embodiment of a pay-per-minute system of the present invention.

FIG. 1B illustrates a media presentation catalog page and a full presentation viewing window page of the system of FIG. 1A.

FIG. 2 illustrates a flow chart summarizing an embodiment of a process for handling events via a composite plug-in.

FIG. 3A illustrates another embodiment of a full presentation viewing window page prior to the user starting creation a clip.

FIG. 3B illustrates the full presentation viewing window page of FIG. 3A after the user chooses the start time for a clip.

FIG. 3C illustrates an embodiment of a clip viewing window page.

FIG. 4 illustrates a flow chart summarizing an embodiment of a process for creating a clip.

FIG. 5A illustrates an embodiment of a clip management page.

FIG. 5B illustrates the clip management page of FIG. 5A after a user has selected to edit a clip having a clip identifier entitled “Amazing Shot”.

FIG. 6 illustrates a flow chart summarizing processes for viewing a clip.

FIG. 7A illustrates an embodiment of a composite clip creation page.

FIG. 7B illustrates an embodiment of a composite clip management page.

FIG. 8 illustrates a flow chart summarizing a process for managing composite clips.

FIG. 9 illustrates a flow chart summarizing processes for viewing composite clips.

FIG. 10 illustrates an embodiment of a composite clip viewing window page.

### DETAILED DESCRIPTION OF THE INVENTION

Several embodiments of the present invention are discussed below in connection with a pay-per-minute service in which audio/video media presentations (for example, previously recorded sports events or games) can be streamed to a client computer via a network such as the Internet. For a customer or client to view a sports event media presentation or parts of a sports event media presentation on a stream by minute basis, the customer first purchases time and logs into the customer's account. Once these requirements have been met, a customer can view any “video on demand” or VOD stream provided by the vendor/server. A customer searches for the desired sports event media presentation and clicks on an identifier, tag or hyperlink associated with that media presentation to watch the sports event media presentation. In one embodiment, at this time a viewing window web page displays and attempts to stream the requested file. In the described representative embodiments, the various functions of the invention are set forth in a number of web pages that can be browsed/activated by a customer/user of a pay-per-minute system.

One skilled in the art appreciates, however, that devices, systems and methods are applicable to any type of digital media presentation (for example, sports events, movies, adult movies, education lectures or seminars etc.) which can be streamed to a client computer, downloaded to a client computer or previously saved on a client computer on a pay-per-view basis or free basis. The devices, systems and methods of the present invention are particularly useful in connection with the creation of clips and composite clips of digital video/multimedia presentations. In general, the term “media presentation” is used in connection with an object of perception (typically, audio, video and/or combinations thereof) adapted to be perceived by one or more human senses over a period of time. The term “clip” refers generally an object of perception that includes a portion of a media presentation (that is, having a starting time and an ending time within the starting time and ending time of the media presentation). The term “composite clip” refers generally to a collection of a plurality of clips.

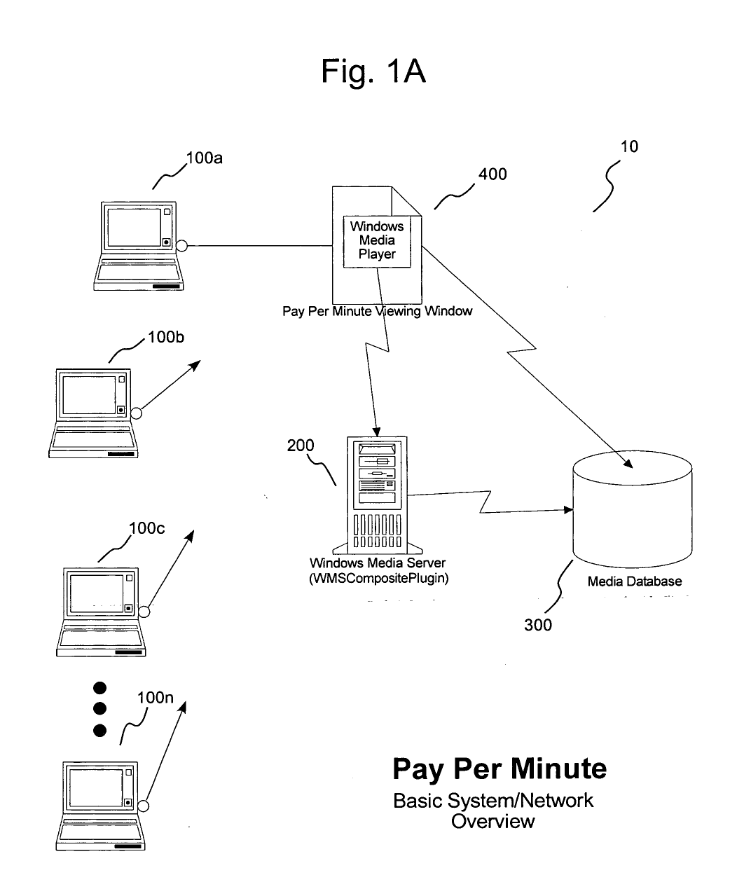

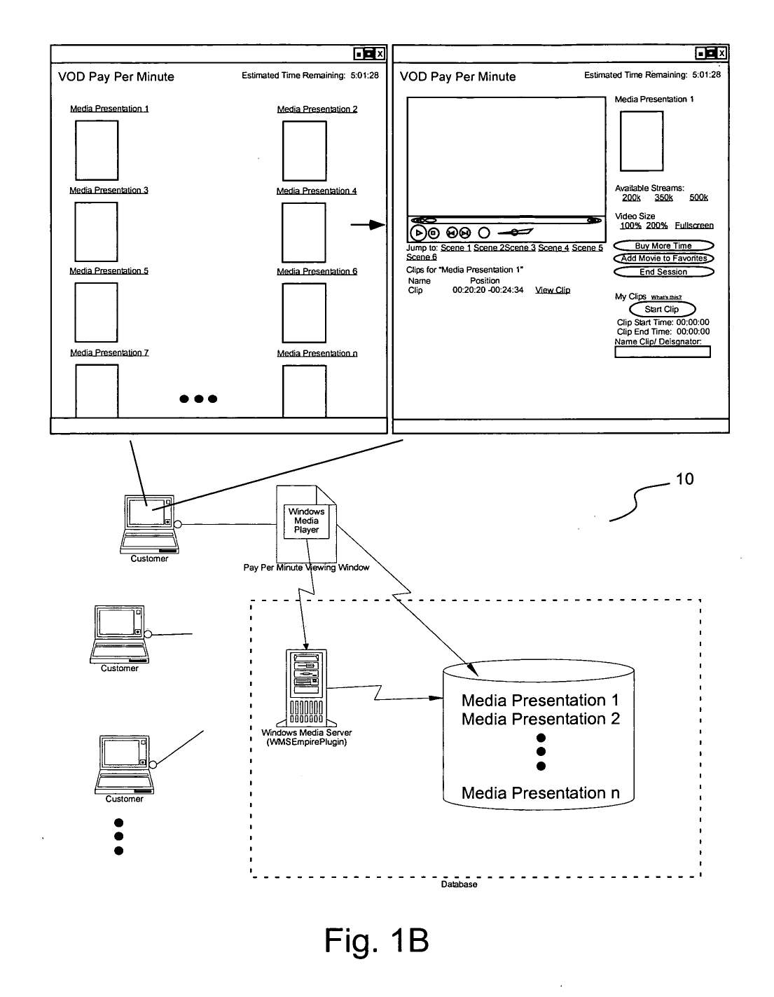

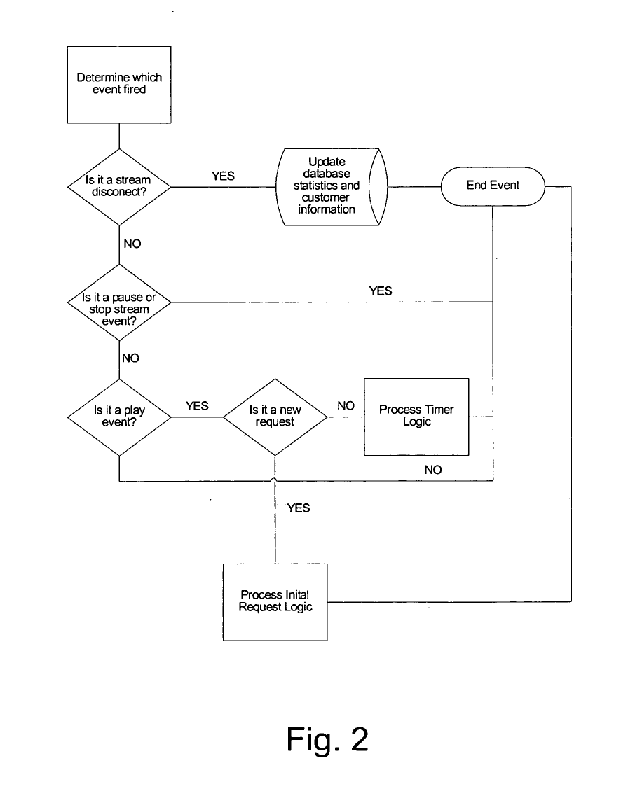

FIG. 1 illustrates an example of a system 10 via which a plurality of media presentation such as sporting events or movies can be streamed to one or more of several client computers 100a through 100n, which are in communicative connection with a server system 200 which is in communicative connection with or includes a memory system 300 having stored therein a database of digital files corresponding to the plurality of media presentations. In one embodiment, a pay-per-minute plug-in handles the monitoring and validation of all streaming media files. The plug-in can, for example, be built on the .Net Framework designed in C# utilizing the WINDOWS® Media Server Event Notifications. The plug-in can operate as a Windows Media Server Event Plug-In which handles connect, play, stop, and disconnect events (see, for example, FIG. 2). These events are captured within the plug-in and handled accordingly. As used herein, the term “plug-in” refers generally to a software module that adds a specific feature or service to a larger system.

The plug-in can be designed as a single composite plug-in which holds or includes several other plug-ins. In one embodiment, such plug-ins or features within the composite plug-in included, for example: player information storage, query string parsing, statistics tracking, SQL database support, and stream validation.

The composite plug-in provides the foundation for streaming video-on-demand or VOD services. It is also an integral part of pay-per-minute, clip and composite clip technologies described herein.

As described above, the composite plug-in includes multiple plug-ins within the main plug-in. In one embodiment, the composite plug-in was installed on server system 200 (which can include one or more computers or servers) in communicative connection with memory system 300 storing all of the streaming media data files available for streaming. The composite plug-in was written as an event notification plug-in and captured all events when a stream was accessed on media server system 200. The overall functionality of the composite plug-in is summarized as follows:

1. Initialization:
a. Initialization occurs when the plug-in is started by server system 200.
b. The Composite Plug-in grabs references to the server and the event log for whenever they may be needed by the various internal plug-ins within the composite plug-in.
c. The Composite Plug-in creates the various plug-ins and stores them in a collection.
d. The Composite Plug-in cascades the Initialization of these plug-ins.

2. Event Notification:
a. The Composite Plug-in captures the events and cascades them to all the plug-ins when supported.

3. Destruction:
a. The Composite Plug-in cascades the Destruction to all of the plug-ins within the collection.

A statistics plug-in of the composite plug-in handles tracking of all statistics involved with the playing of streaming media data files. The data can be stored in a database to be used for reporting and monitoring of streams. In one embodiment, basic data collected by the statistics plug-in included: requested file, starting time, stopping time, total length of time played, and the customer requesting the file. The functionality of this plug-in is summarized below:

1. Initialization:
a. None Needed

2. OnBeginUserSession:
a. Occurs when the client is connected to the requested stream.
b. Creates a new entry in the database for the requested file. Stores the client requesting (if available) the file, the file requested, and the connect time.

3. OnEndUserSession:
a. Occurs when the client is disconnected from the media stream.
b. Updates the database with the disconnect time and the total length of time the file was streamed.

4. OnPlay:
a. Occurs when the file has begun streaming to the client.
b. The plug-in determines if the OnPlay event is occurring for the first time or if it was a restart.
c. If it is a first time play the plug-in updates the database with the first play time and determines if the requested file is a sample stream.
d. If it is a restart the database is updated with a last played time.

5. OnStop:
a. Occurs when the client presses the stop or pause button on the stream.
b. The database is updated with the time the stream was stopped.

6. OnForceDisconnect:
a. Occurs when the client is forced to disconnect through various plug-in logic.
b. Calls the OnStop and OnEndUserSession events.

A pay-per-minute plug-in of the composite plug-in handles functionality necessary for stream by minute video-on-demand. The functionality of this plug-in is summarized below:

1. OnPlay:
a. The plug-in first checks to see if the stream is a pay-per-minute type of stream. If it is not, no additional processing takes place.
b. If it is the first play event on the stream, the plug-in stores the data about the stream and the player requesting the file.
c. The plug-in records the time left on the customer's account and stores this information to be used later for validation of time remaining.

2. OnHeartbeat:
a. This event is called at a set interval for the entire main plug-in and is cascaded down to this event.
b. Upon firing of this event, the plug-in loops through all of the connected streams and determines which ones are stream by minute.
c. Each stream is evaluated and checked against the customer's remaining time.
d. If the customer has time remaining on their account the stream remains active and the customer's time remaining is decremented by the heartbeat interval.
e. If the customer has no time remaining the stream is forcibly closed.

A rule enforcement plug-in of the composite plug-in handles validation of requested streams. The functionality of this plug-in is summarized below:

1. OnPlay:
a. The OnPlay event first checks to see if the stream is a sample stream. If it is a sample stream, no further validation is done during this event.
b. If the stream is not a sample, it is therefore requested by a customer and that customer id should have been passed in during the request to play the file.
c. If no customer id is present or the customer id is invalid, then the stream is forcibly disconnected.
d. If the stream is a pay-per-minute stream, no further validation is required during this plug-in event. The enforcement will take place in the Pay-Per-Minute plug-in.
e. If the stream is a customer purchase of the movie, the stream is validated against the database to ensure that the customer has indeed purchased the movie. If the customer has not purchased the requested movie, the stream is forcibly disconnected.

In one embodiment, full or complete media presentations were presentable through a pay-per-minute viewing window 400 which existed as a web page on server system 200. Web page 400 contained an embedded WINDOWS MEDIA PLAYER or other media player 410 which connected to the server system 200 to stream the requested media presentation data file. The page contained logic to stream a full movie, stream a clip, stream a composite, create new clip, jump to different points, periods and/or scenes in a media presentation, display time remaining on a customer account, and disconnect a customer from a stream when necessary.

Viewing window web page 400 was coded in ASP (Active Servers Pages) code, JavaScript and DHTML. This coding provided for dynamic page updates and creation of clips. Although web page 400 can exist as a web page with an embedded window, it is possible to stream a file outside of such a window with enforcement of streams taking place as described above through the composite plug-in. For example, a user application can be provided to customers for download to view their streams. This application can, for example, run on all Windows machines and can create an easy graphical user interface or GUI for all of the features provided through web page 400. The application can, for example, include an embedded player (for example, Windows Media Player) that connects to server system 200 via an internet connection. All features described herein for web page 400 can be available and coded using, for example, Windows Web Services.

Before a media presentation can stream to a client computer, a few validation rules and requirements must first be met. For example, all VOD streams can be encrypted to prevent theft using, for example, Microsoft (Digital Rights Management) DRM, available from Microsoft as a Microsoft Security Update on their Windows Media Player. This procedure needs to occur only once and not prior to every requested stream. As viewing window web page 400 first loads, a license is delivered to media player 410 for the requested encrypted stream. Embedded media player 410 on web page 400 then attempts to connect to the requested data file on server system 200. At this time, the composite plug-in fires and a validation is performed on the stream as described above.

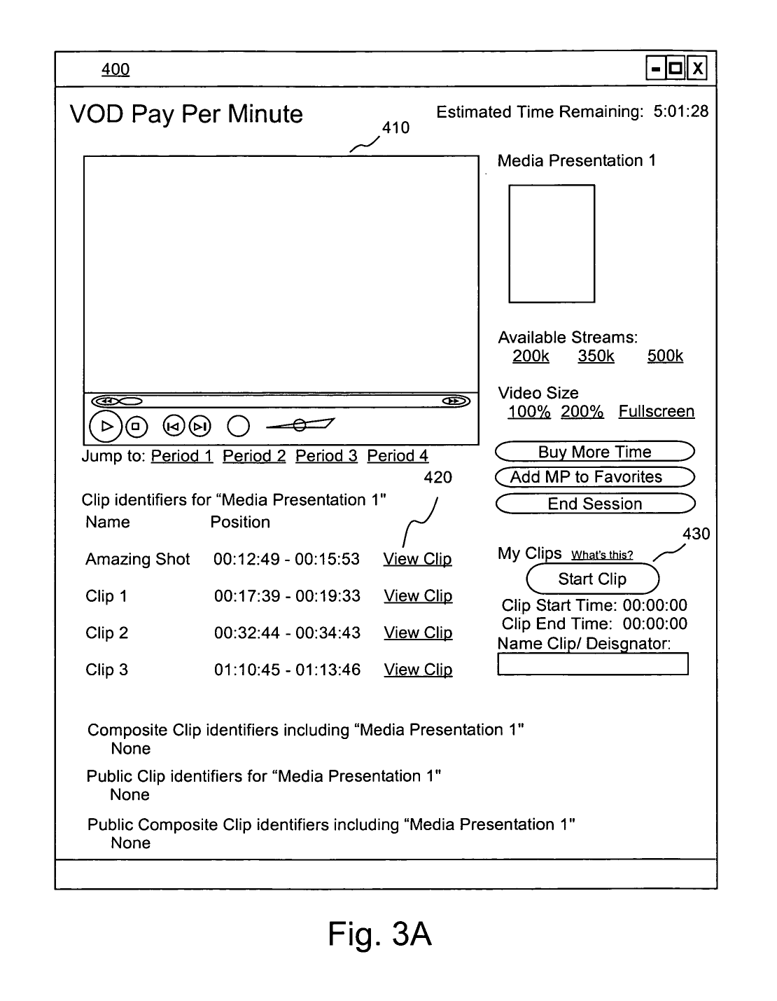

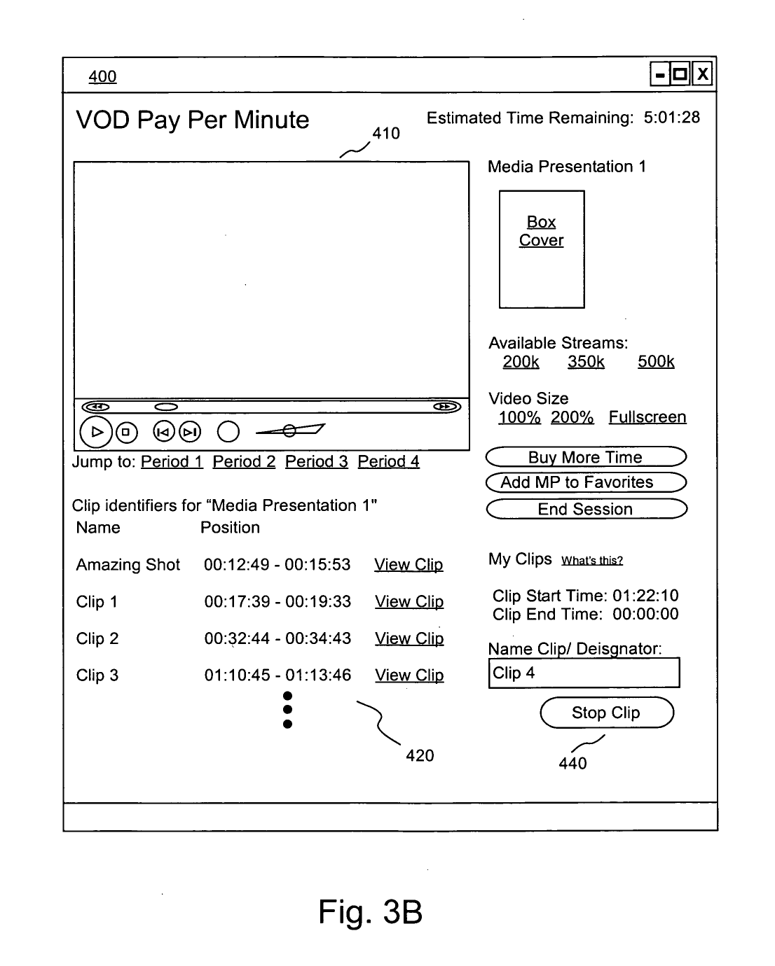

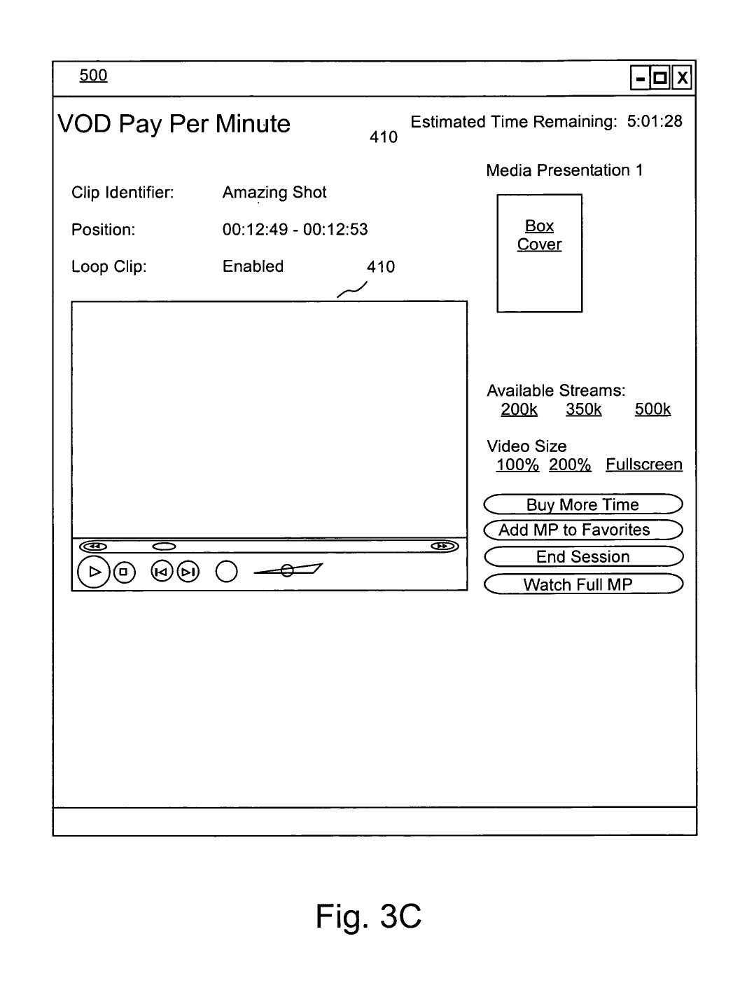

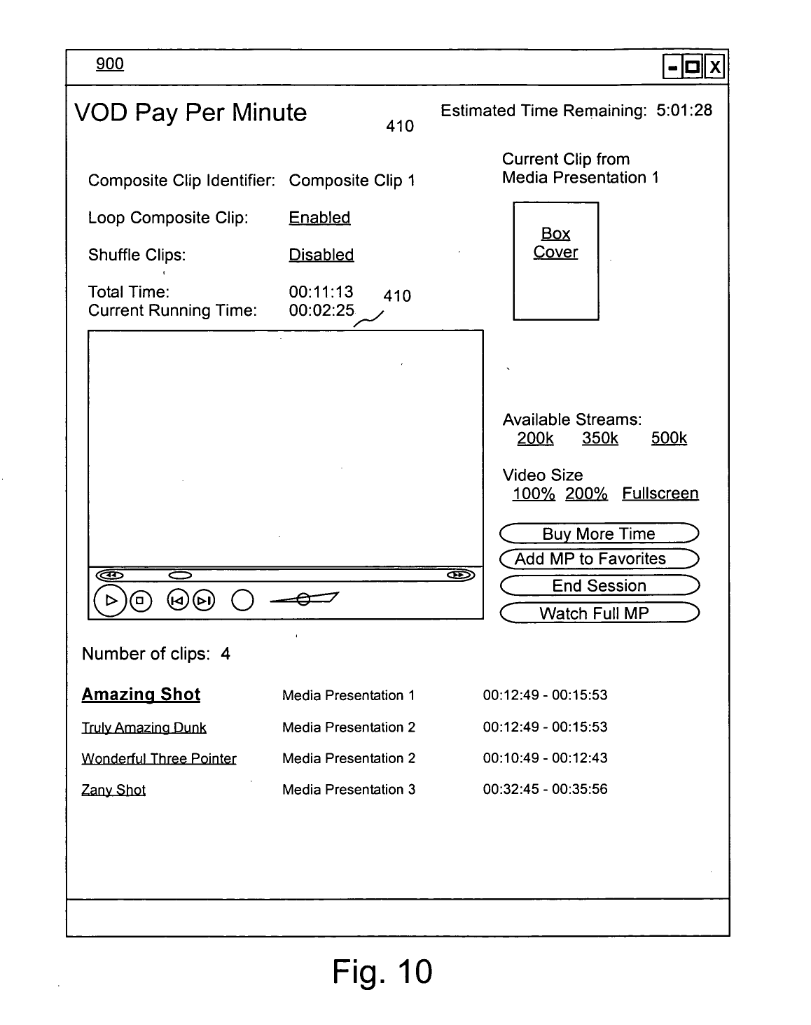

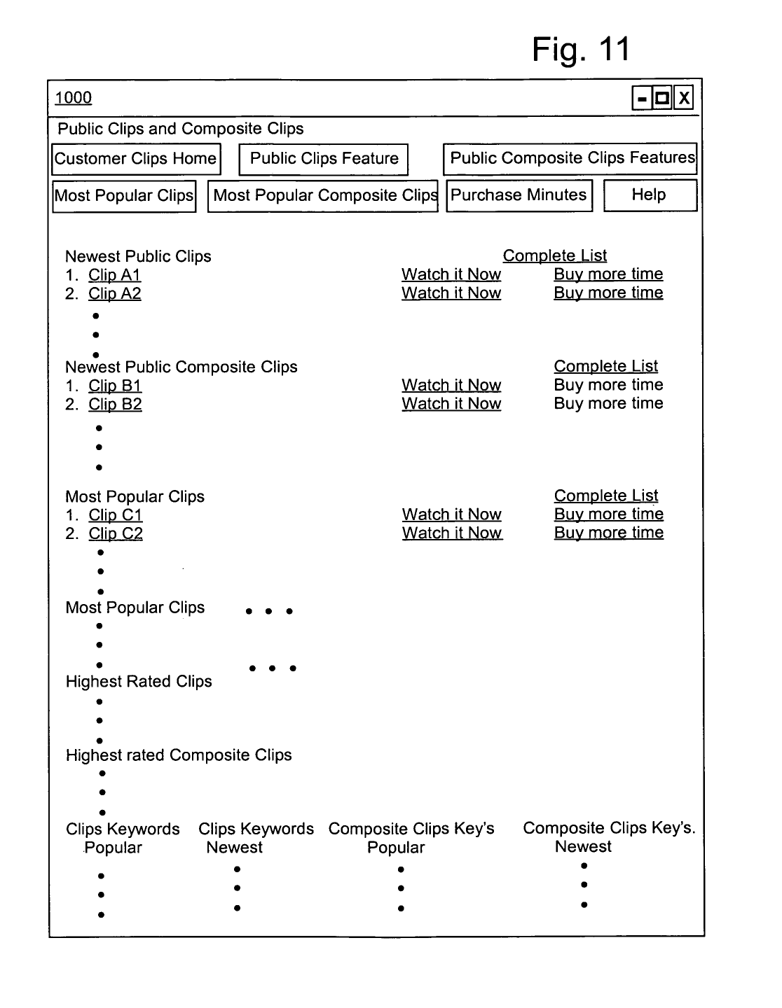

As the file data is streamed to the client's computer, the stream can be stopped, paused, viewed in fast-forward, rewind or at normal speed. If a customer's time runs out at any time, the stream can be disconnected and the customer can be redirected to another web page where the customer can add additional time to the customer's account. Features provided to the customer or client in viewing window web page 400 can, for example, include:
1. Media Presentation Information: For example, a title of the media presentation, a box cover of a DVD associated with the media presentation, and other pertinent information about the media presentation can be provided as a reference to the customer.
2. Change of Stream Rates: If multiple stream rates are available for the current media presentation, the customer is provided an opportunity to view and select the different stream rates.
3. Change Picture Size: The customer can choose to view the stream at, for example, 100%, 200% or full screen video size.
4. Add More Time: An easy method for adding additional time onto an account can be provided from this screen.
5. Add to Favorites: The customer can click a button to add the media presentation to a list of favorites.
6. Remaining Time: The time remaining on a customer's account can be displayed and can decrement every second while the stream is playing.
7. End Session: Customers can be provided an easy method of ending the stream by clicking a single button to end the session.
8. Jump to Period or Scene: If period or scene indexing exists for the media presentation, the customer can click on the desired period or scene and the stream will be directed to stream from that point in the media presentation.
9. Display clip identifiers 420: If a customer has created any clips for the current media presentation, a corresponding clip identifier 420 can be presented to the customer on web page 400. A customer can click on a desired clip identifier 420 to open a clip viewing web page 500 (see FIG. 3C) and a stream will play the media presentation from the start time to the end time associated with that clip.
10. Create a new clip: While watching a media presentation a customer can create a new clip by clicking on a start button 430 (see FIG. 3A) at the desired start time, then clicking an end or stop button 440 (see FIG. 3B) at the desired ending time.
11. Display of composite clips: As with clip identifiers 420, any identifiers for composite clips (described in further detail below) created by the customer that include a clip of the current media presentation as a part of the compiled composite clip presentation can be presented to the customer. A customer can click on the desired composite clip identifier and viewing window web page 400 will change to a composite clip viewing window web page 900 (see FIG. 10) and the composite will begin playing.
12. Display of public clips: If any clips have been created for the media presentation by another customer which are tagged or identified as public viewable, such public clips can be displayed on web page 400. The customer can click on the desired public clip identifier and the stream will be directed to play the movie from the start time to the end time associated with the clip identifier.
13. Display of public composite clips: As with public clips, any composite clips created by another customer that include a clip of the current media presentation as a part of the composite or compiled composite clip and are tagged as public viewable can be presented to the customer. A customer can click on the desired public composite clip and the viewing window will change to a composite clip viewing window web page 900 and the public composite clip will begin playing.
14. Display of the custom categorization tags: Customers can have the ability to custom categorize or describe full media presentations, clips and composite clips. This functionality provides a way to search for desired media presentations, clips and/or composite clips matching certain custom categorization criteria. If the media presentation, clip or composite clip has been tagged with any custom criteria, these criteria can be displayed to the customer.

The ability to create clips provided by the present invention allows a customer or client to choose any part or parts of one or more media presentations and create a catalog of clips of such media presentations. The clip creation function of the present invention allows a customer to create as many clips from a single media presentation or multiple media presentations as desired. Clip identifiers 420 corresponding to and associated with these clips are stored in memory system 300 and are available for the customer to view at any time with the option of making clips available for the public (other customers) to view as well. Appropriate user interfaces allow the customer to create a clip by selecting when to start the clip and when to end the clip, create a custom name for the clip, make the clip public or private, and custom categorize the clip with preset keywords and/or user defined keywords.

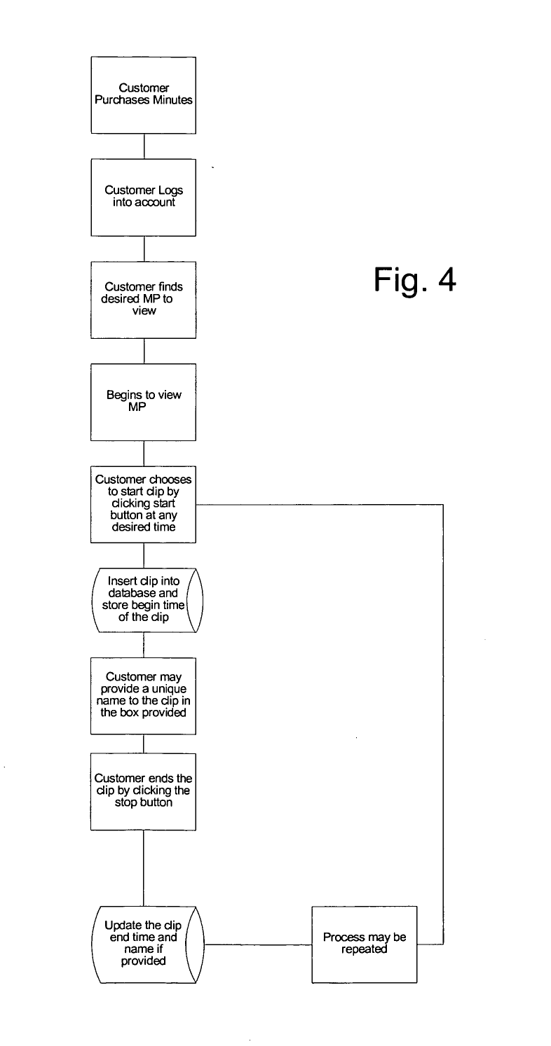

While watching a streaming media presentation in web page 400, the customer can create a clip of a portion or part of the currently playing media presentation by first activating or clicking start clip button 430 (see FIG. 3A) at the desired starting time. When start clip button 430 is activated, a clip identifier 420 is created and the start time information is stored in a database in memory system 300. Once start clip button 430 is activated and clip identifier 420 is created, a field is presented to the customer as illustrated in FIG. 3B so that a custom name can be entered by the customer for the clip. This creation of a custom name is not required. An automatically generated name or default name can be provided by the system if no custom name is entered. The name can be modified at any time through the one or more clip management interfaces as discussed further below. The customer activates a stop clip button 440 at the time when the customer wants the clip to end. If stop clip button 440 is not activated, the end of the media presentation can be used as the ending time of the clip. One embodiment of this process is summarized in a flow chart set forth in FIG. 4.

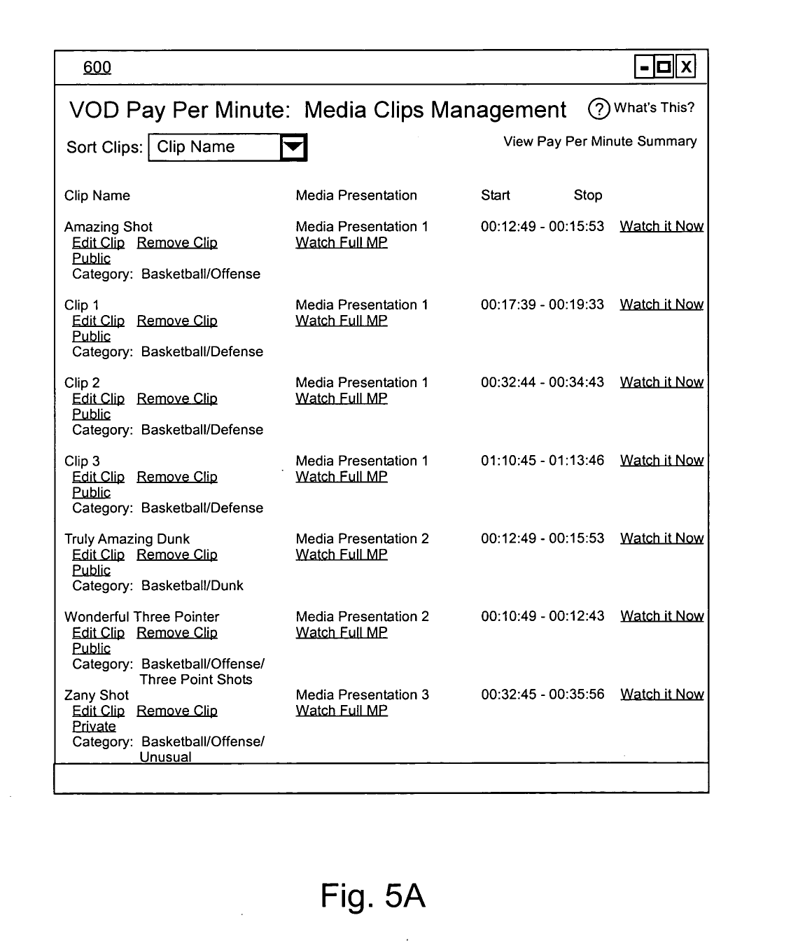

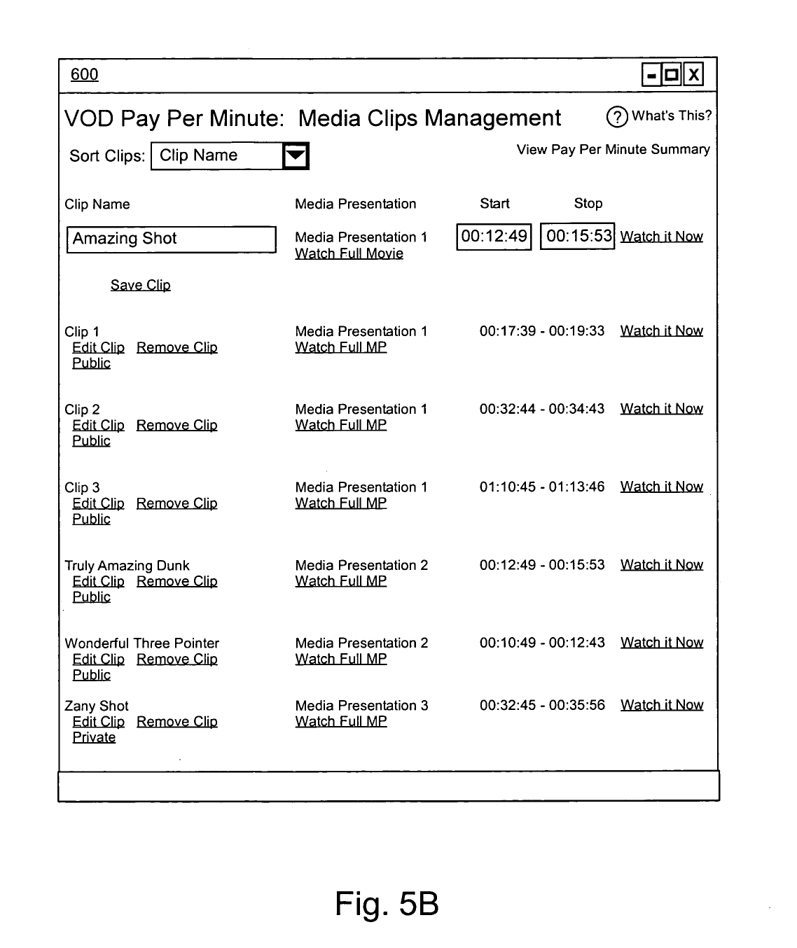

An embodiment of a clip management interface or web page 600 is illustrated in FIGS. 5A and 5B. Management of clips, including, for example, editing and deleting, can be performed via interface or web page 600. As illustrated, for example, in FIG. 5B, the customer is, for example, able to edit the name of a clip identifier, edit the starting and ending times of a clip, make the clip public or private (for example, via a toggling switch), custom categorize a clip, and see a report of the viewing history of a clip. When a clip is created, the clip can default to either public or private, depending upon which default state the customer has selected as the default for their account. Each clip may be modified as public or private via clip management interface web page 600. Making a clip public provides all customers the ability to view the clip. Making a clip private provides only the creating customer the ability to watch the clip. Any clips that are tagged as public can be made available for the entire customer base to view by inclusion in various lists made available to customers in one or more web pages, in any software applications that may be created, and in full movie viewing window 400.

As described above, customers can categorize full media presentations, clips and composite clips as illustrated, for example, in FIG. 5A. Once the media presentation, clip or composite clip has been tagged with any custom criteria, these criteria are displayed to the customer(s). The customer can add categories or descriptions from a preset list of keywords, performers, and categories, or the customer can create their own.

Various data or statistics and copying functionality can be provided to the customer, for example, upon clip activation. For example, the customer can be provided with data including how many times the customer has watched a particular clip, the last time the customer watched the clip, and the total amount of time spent watching a clip. The customer can also be provided with data including how many times other customers have viewed a clip or how many times a clip has been copied by other customers.

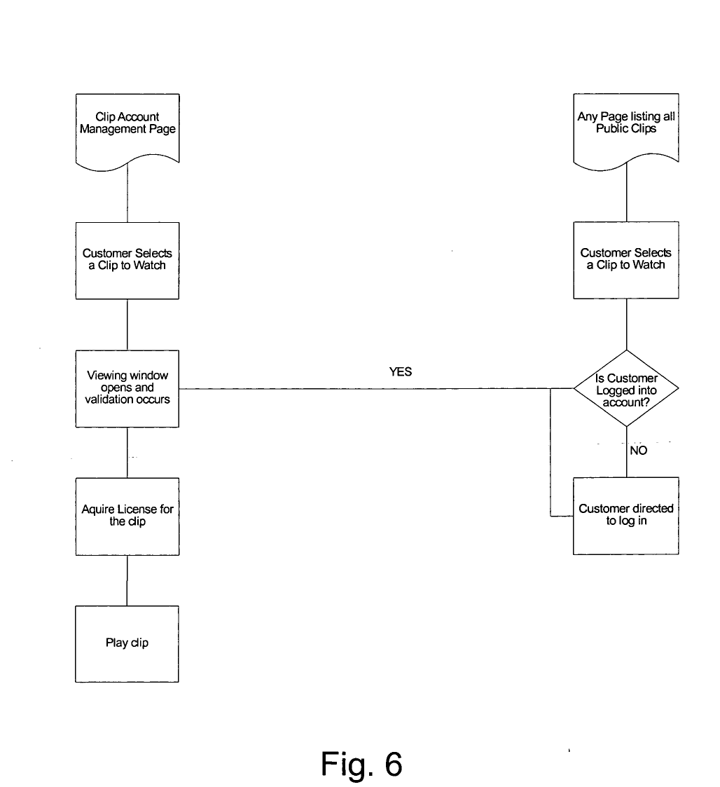

Viewing a clip can be initiated a number of ways. For example, once one or more clips have been created, the customer can view any of the clips they have created by selecting the associated clip designator from the catalog of clips set forth in management interface web page 600. An embodiment of this process is summarized in a flow chart set forth in FIG. 6. Additionally, all available public clips can accessed as set forth above. After selecting a clip designator corresponding to a certain clip, pay-per-minute clip viewing window 500 opens and the stream begins to play by streaming data from the media presentation data file from which the clip was created. If a customer is viewing a publicly viewable clip that was not created by the customer, the customer is provided with the option of copying the public clip to their own catalog. Copying a clip creates a new clip identifier or designator for the customer and places it into their catalog of clips/clip identifiers. The copied clip designator can be exactly the same as the clip designator corresponding to the clip the customer was watching. A reference to the clip from which it was copied can also be provided. This process can facilitate providing reporting to the clip originator as to which clips are being watched and copied. A copied clip can be subject to all management options described above.

In general, the main process or processes when viewing a clip and in displaying of clip viewing window web page 500 remain the same as when viewing a full media presentation. The same requirements and validation take place, and many of the provided features are the same as provided in full presentation viewing window web page 400. A primary difference is that the clip presentation begins at the starting time associated with the clip and stops at the ending time associated with the clip. The clip can, for example, be stopped, paused, and viewed in fast-forward or rewind. The custom name of the clip (if provided) or a default name as well as the starting and ending time of the clip can be displayed for the customer. If the customer wishes to watch the full media presentation, a corresponding button can be activated and the media presentation will start from the beginning thereof and will display in full media presentation viewing window web page 400. By clicking a loop or repeat link or activation button, the clip can be looped or repeated indefinitely until the feature is turned off. As discussed above, the customer can be provided with the ability to categorize or describe via keywords or categories the clip they are watching. If the clip has been tagged with any custom criteria, these criteria can be displayed to the customer. If a customer's time runs out at any time during the presentation, the stream is disconnected and the customer can be redirected to a page where the customer can add additional time to their account.

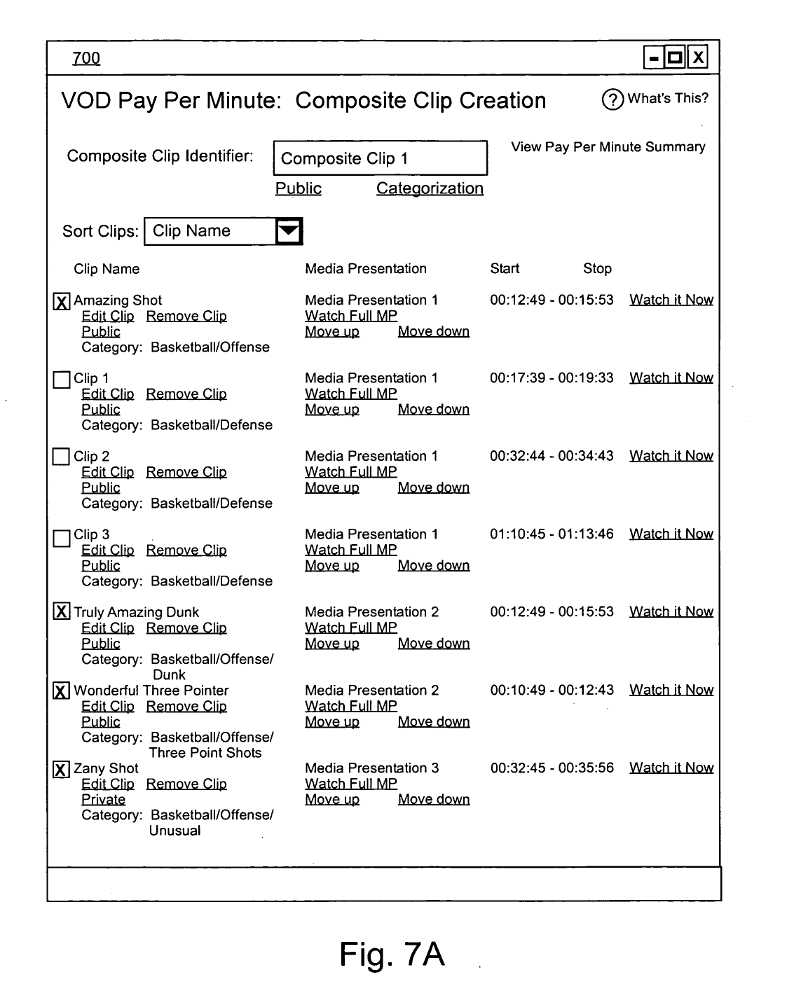

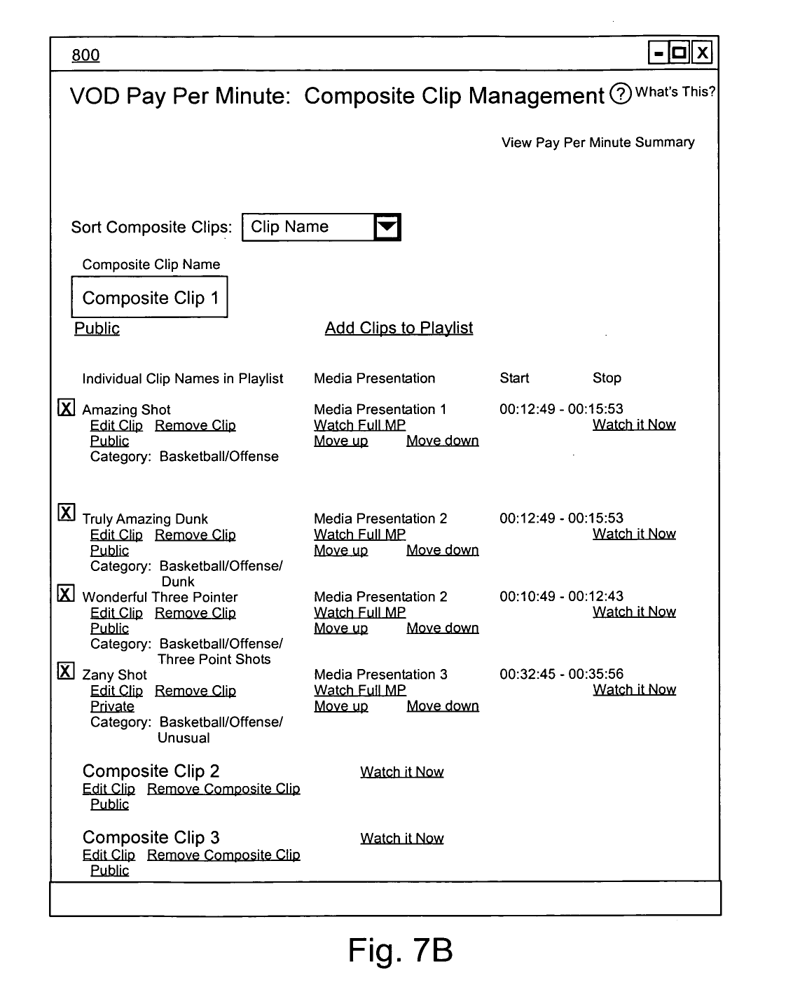

Composite clip functionality provides a customer with the ability to splice together more than one clip into a single stream or play list. Composite clip creation relies on the clip creation technologies and the customer creation of a plurality of clips is necessary to create a composite clip. Composite clip identifiers are stored and made available for the customer to view at any time with the option of making associated composite clips available for the public to view. This functionality can, for example, be accomplished through one or more user interfaces such as composite clip creation window web page 700 as illustrated in FIG. 7A. Web page 700 allows the customer to create a composite clip by selecting which clips to include or exclude (for example, via a check box or an add/remove button), to define the order in which the associated or included clips will be played, to provide a custom identifier name for the composite clip, to make the composite clip public or private, and to custom categorize the composite clip with, for example, preset keywords and/or user defined keywords. Any composite clips that are tagged as public will be made available for the entire customer base to view. Public composite clips can, for example, be included in various web page lists, in software applications, and/or in full movie viewing window web page 400. As a clip is added to the current composite clip, it can, for example, be placed at the end of the play list. The customer can change the order the clips in a composite by, for example, selecting a move up option or a move down option. Statistics reporting similar to that described above in connection with clips can be provided to the customer.

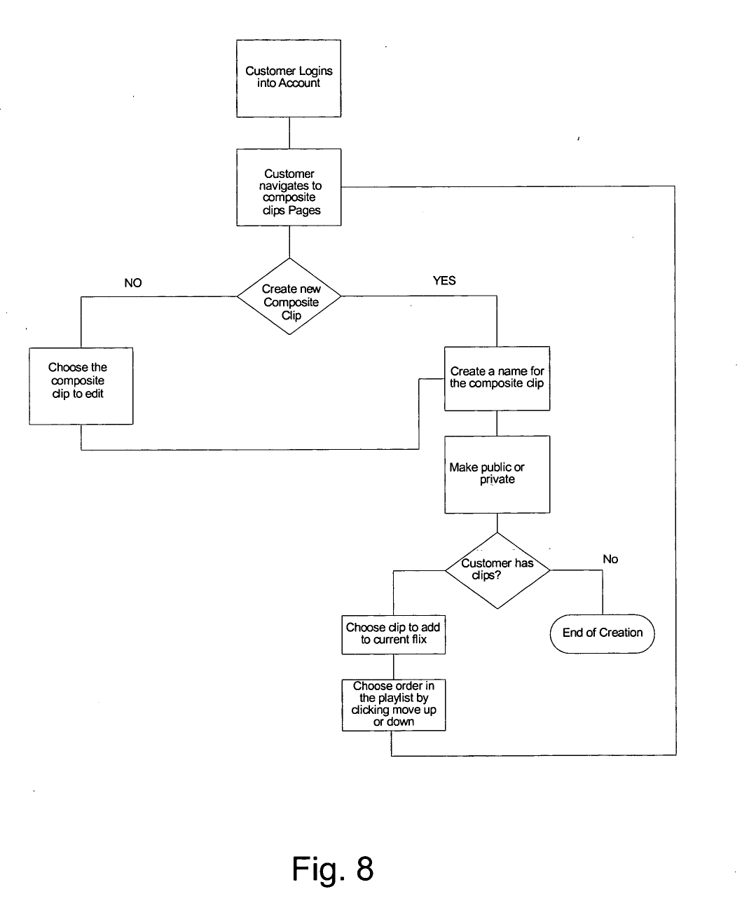

Management of composite clip, including, for example, editing and deleting, can be accomplished via a composite clip management user interface web page 800 as illustrated in FIG. 7B. The customer can first navigate to web page 800 and select a composite clip for presentation, editing etc. from the available options. Interfaces for the management of composite clips can also or alternatively be placed into a software application available to customers. Management of composite clips is also summarized in the flow charts set forth in FIG. 8.

The customer can, for example, edit the clip identifier name associated with the composite clip, make the composite clip public or private, custom categorize the composite clip, add or remove clips from the composite play list, and determine the order in which the clips will be played upon presentation of the composite clip. All of the composite clips created by a customer can, for example, be cataloged and stored for easy retrieval by the customer on web page 800. Similar to the case of clips described above, making a composite clip private allows only the creating customer the ability to view the composite clip. Each included clip may be modified as public or private on an individual basis at any time. When the composite clip is first created, the composite clip can be defaulted to public or private depending upon which default state the customer has selected as the default.

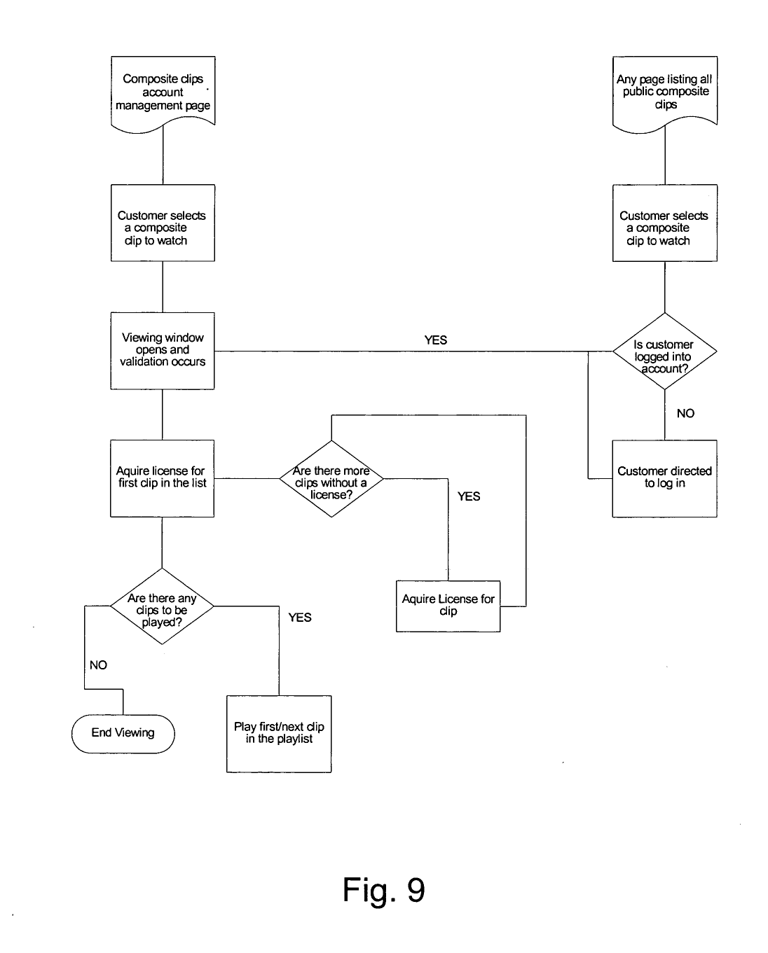

Viewing of a composite clip can be initiated a number of ways as, for example, summarized in the flow chart of FIG. 9. For example, once a composite has been created, the customer can view any of the composite clips the customer has created by selecting the desired composite clip from the catalog of composite clips set forth on web page 800 (which can, for example, be made available within a general account management page). Additionally, as set forth above, all available public composite clips can be listed in various manners. After selecting a composite clip to view, a pay-per-minute composite clip viewing window web page 900 (see FIG. 10) opens and the stream begins to play. If a customer is viewing a public viewable composite clip that was not created by the customer, the customer has the option of copying that composite clip to the catalog of the customer.

Composite clip viewing window web page 900 provides many of the features of full presentation viewing window web page 400 and clip presentation viewing window web page 600 described above. For example, media presentation information can be provided for the currently playing clip. This information can change, as appropriate, to correspond to the currently playing clip of the composite clip. In that regard, the information can change based upon the media presentation from which the clip was created. As described above, available stream rates, available video sizes, an add more time option, an add to favorites option, an end session option, and time remaining can be set forth.

Additionally, the custom name (if established) associated with the composite clip identifier or the default name associated with the composite clip can be displayed. The number of clips included and the total running time of the composite clip can be provided. A list of all the clips and the order the clips will stream can be displayed to the customer. The current clip that is streaming can be highlighted for customer ease. The customer can choose to jump to any clip in the composite clip by simply clicking on the clip identifier for the clip that they would like to view. As with clips, the customer can choose to loop or repeat the current composite clip. If the loop feature is enabled, as the final clip finishes, the first clip will be streamed and the cycle will continue until the feature is disabled. A shuffle feature can also be provided. If the shuffle feature is enabled, the composite clip will stream the included clips in a random order instead of the order defined by the customer when the composite clip was created.

As with individual clips, the main requirements and validation rules set forth above apply to composite clips viewing window web page 900. Upon starting of the composite clip, the first clip in the composite clip is played. As the first clip is playing, the remaining clips in the composite clip can, for example, have licenses acquired so that they can be viewed.

Once again, while viewing a public composite clip created by another customer, the option to copy that composite clip is provided to the customer. Copying creates a new composite clip identifier for the customer and saves the composite clip identifier into the customer's catalog of composite clip identifiers. The copied composite clip can be generally the same as the copied composite clip with a reference to the copied composite clip. Such referencing can facilitate reporting to the copied composite clip originator as to which composite clips are being watched and/or copied. A copied composite clip can have all management options described above associated therewith.

Statistics can be maintained in, for example, a database stored in memory of server system 200 regarding various aspects of clips and/or composite clips. As, for example, illustrated in the representative web page of FIG. 11, listings can be provided on the basis of newest created public clips and/or composite clips, most popular (or most viewed) clips and/or composite clips, highest rated clips and/or composite clips, etc. The listings can provide clips/composite clips identifies and other information. Several (for example, ten) clips and/or composite clips can be listed in each category with an option or link to enable viewing of a complete list in each category. As also illustrated in FIG. 11, statistics can also be stored with respect to descriptive keywords entered by users as described above. A rating system can be established so that users can rate one or more aspects clips and/or composite clips. Moreover, users can be provided with the ability to enter comments on their clips/composite clips and the clips/composite clips of others. Moreover, users can be provided with the ability to identify aspects such as certain other users, certain subjects, certain keywords etc. so that the user is provided with a notice that a new public clip/composite clip has been added that falls within one of the user's identified aspects. Such notice can, for example, be provided via RSS Feed as known in the computer art, via email, etc. A user can, for example, subscribe to a certain aspect via RSS feed. Subsequently, each time a clip or composite clip is added satisfying the aspect, the subscribed user receives a RSS Feed update notifying the user of the addition. RSS feeds can also be provided for statistical categories such as most popular, highest rated etc. In general, RSS makes use programs called feed “readers” or “aggregators”. As described above, the user “subscribes” to a feed by supplying to a reader program a link to the feed. The reader program can then check the user's subscribed feeds to see if any of those feeds have new content since the last time it checked. The reader can also retrieve that content and present it to the user.

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A system comprising:
a memory system having stored therein at least one file executable to output a media presentation that plays over a period of time;
at least one computer comprising at least one processor and at least one memory, the memory of the computer having a media program stored therein that is executable by the processor of the computer to receive data of the at least one file stored in the memory to present the media presentation to a user;
a communication system providing communication between the computer and the memory system;
a clip creation system adapted to receive input regarding a starting point for at least one clip of the media presentation and input regarding a stopping point of the clip of the media presentation, the clip corresponding to a portion of the media presentation beginning at the starting point and ending at the stopping point; the clip creation system adapted to create a clip identifier for the clip so that upon activation of the clip identifier by a user, the media program receives data from the file and presents the clip.

2. The system of claim 1 wherein the starting and stopping points may be modified by the user.

3. The system of claim 1 further comprising a composite media presentation creation system comprising a mechanism to create a composite identifier for the composite media presentation in which a plurality of clips are grouped and associated with the plurality of clip identifiers, activation of the composite identifier causing presentation of the composite media presentation in which each of the plurality of clips is presented in series.

4. The system of claim 3 wherein the plurality of clip identifiers are grouped in the composite identifier in a defined order such that activation of the composite identifier causes presentation of the plurality of clips in the defined order.

5. The system of claim 4 wherein the memory system has stored therein a plurality of files, each of the plurality of files comprising data of the media presentation corresponding to that file, each of the media presentations playing over a period of time upon execution of the corresponding file.

6. The system of claim 5 wherein at least two of the plurality of clips correspond to different files.

7. A system of claim 1 wherein the clip creation system comprises a user interface comprising, an output mechanism to present media presentations to a user, an input mechanism to define the starting point of the at least one clip upon activation of the input mechanism at the starting point during output of the media presentation, the media presentation being presented via the output mechanism upon receipt of data of the computer file corresponding to the media presentation by the media program, the user interface further comprising an input mechanism to define the stopping point upon activation of the input mechanism at the stopping point during output of the media presentation.

8. A clip creation system comprising a clip creation program adapted to receive input regarding a starting point for at least one clip of a media presentation that is presentable upon receipt of data from a media file stored in a memory, the clip creation program comprising an input mechanism to define a starting point of the clip of the media presentation and an input mechanism defining a stopping point of the clip of the media presentation, the clip corresponding to a portion of the media presentation beginning at the starting point and ending at the stopping point; the clip creation system adapted to create a clip designation for the clip so that upon activation of the clip designation by a user, the media program received data from the media file and presents the clip.

9. A method for creating clips comprising:
providing input for a starting point of a clip, the clip corresponding to a portion of at least one media presentation that is presentable upon receipt of data of a computer file corresponding to the media presentation by a media program, the clip beginning at the starting point and ending at a stopping point;
providing input for the stopping point of the clip; and
creating a clip designation comprising the starting point and the stopping point that, when activated by a user, causes the media program received data of the file and present the clip.

10. A clip presentation system comprising:
a user interface comprising, an output mechanism to present media presentations to a user, an input mechanism to define a starting point of a clip upon activation of the input mechanism at the starting point during output of a media presentation, the media presentation being presented via the output mechanism upon receipt of data of a computer file corresponding to the media presentation by a media program, the clip corresponding to a portion of the media presentation that is presentable upon execution of a computer file corresponding to the media presentation by a media program, the clip beginning at the starting point and ending at a stopping point, the user interface further comprising an input mechanism to define the stopping point upon activation of the input mechanism at the stopping point during output of a media presentation.

11. The clip presentation system of claim 10 wherein the clip comprising a designator that when activated causes the media program to access data of the computer file and present the clip.

12. A method for creating a composite media presentation comprising a plurality of clips, the method comprising:
creating a plurality of clip identifiers, each of the clip identifiers comprising a starting point identifier for a corresponding one of the clips and a stopping point identifier for the one of the clips;
storing the clip identifiers; and
creating a composite identifier for the composite media presentation by grouping the plurality of clip identifiers and associating the plurality of clip identifiers with the composite identifier, activation of the composite identifier causes presentation of the composite media presentation in which each of the plurality of clips is presented in series.

13. The method of claim 12 wherein the plurality of clip identifiers are grouped in the composite identifier in a defined order such that activation of the composite identifier causes presentation of the plurality of clips in the defined order.

14. The method of claim 13 wherein activation of the composite identifier causes each of the plurality of clip identifiers to access data of a corresponding computer file storing data of a corresponding media presentation.

15. A media system, comprising:
a database comprising a plurality of media presentations that play over a period of time,
a communication portal adapted to provide communicative connection between the database and a computer;
the computer comprising at least one processor and at least one memory in communication with the database, the memory having stored therein a media computer program executable to present at least one of the media presentations upon receiving a stream of data from the database, the computer further comprising a user interface comprising an output mechanism to present media presentations to a user, an input mechanism to define a starting point of a clip upon activation of the input mechanism at the starting point during output of the media presentation, the user interface further comprising an input mechanism to define a stopping point upon activation of the input mechanism at the stopping point during output of the media presentation, the clip corresponding to a portion of the media presentation beginning at the starting point and ending at a stopping point.

16. A system for presenting media streams comprising:
a memory system having stored therein data of at least one media presentation that is presentable over a period of time;
at least one computer comprising at least one processor and at least one memory, the memory of the computer having a media program stored therein that is executable by the processor of the computer to receive a stream of data of the media presentation to present the media presentation to a user;
a communication system providing communication between the computer and the memory system;
a clip identification system adapted to receive input regarding a starting point for at least one clip of the media presentation and input regarding a stopping point of the clip of the media presentation, the clip corresponding to a portion of the media presentation stream beginning at the starting point and ending at the stopping point; the clip identification system adapted to create a clip identifier for the clip comprising the starting point and the stopping point, activation of the clip identifier by a user causing the computer to receive a stream of data corresponding to the clip.

17. A system for presenting media streams comprising:
a memory system having stored therein data of a plurality media presentations;
at least one computer comprising at least one processor and at least one memory, the memory of the computer having a media program stored therein that is executable by the processor of the computer to received data from the memory and to present the media presentations;
a communication system providing communication between the computer and the memory;
a user interface comprising, an input mechanism to permit the user to select from any of the plurality of media presentations, an output mechanism to present the selected media presentation to the user as data arrives to the computer from the memory system via the communication system; and
a clip identification system adapted to receive input regarding a starting point for at least one clip of the media presentation and input regarding a stopping point of the clip of the media presentation, the clip corresponding to a portion of the media presentation stream beginning at the starting point and ending at the stopping point; the clip identification system adapted to create a clip identifier for the clip comprising the starting point and the stopping point, activation of the clip identifier by a user causing the computer to receive a stream of data from the memory system corresponding to the clip.

18. A method for presenting media streams, the method comprising:
providing data of a plurality of media presentations, each of which is presentable over a period of time, in a memory system accessible by at least one computer in communicative connection with the memory system;
transmitting a stream of data of at least one of the media presentations to the at least one computer;
a media program stored in at least one memory of the computer presenting the media presentations to a user as the stream of data is received;
providing an input mechanism for identifying a starting point of at least one clip,
providing an input mechanism for identifying a stopping point of the at least one clip, the at least one clip corresponding to a portion of the at least one media presentation, the at least one clip beginning at the starting point and ending at the stopping point;
creating a clip identifier comprising the starting point and the stopping point of the at least one clip, activation of the clip identifier causing transmittal of a stream of data to the computer from the memory system corresponding to the at least one clip so that the at least one clip is presented via the media program; and
storing the clip identifier on the memory system.

19. The method of claim 18 further comprising
creating a plurality of clip identifiers, each clip identifier comprising the starting point and the stopping point for a corresponding clip, activation of one of the plurality of clip identifiers causing transmittal of a stream of data to the computer from the memory system corresponding to the corresponding clip so that the corresponding clip is presented via the media program; and
storing the plurality of clip identifiers on the memory system.

20. The method of claim 19, further comprising
creating a composite clip identifier for a composite media presentation by grouping at least two of the plurality of clip identifiers and associating the plurality of clip identifiers with the composite clip identifier, activation of the composite clip identifier causes presentation of the composite media presentation in which each of the plurality of clips is presented in series; and
storing the composite clip identifiers on the memory system.

21. The method of claim 19, further comprising
creating a list of all clip identifiers created by the user and stored on the memory system; and
saving the list on the memory system.

22. The method of claim 21, further comprising
permitting access to at least a portion of the list by another user so that the another user can activate at least one of the clip identifiers created by the user, causing transmittal of a stream of data to a computer of the another user from the memory system so that the corresponding clip is presented via the media program stored on the computer of the another user.

23. The method of claim 22, further comprising
permitting the user to choose whether each of the clip identifiers created by the user is available to the another user.

24. The method of claim 22 further comprising
creating a plurality of clip identifiers of the user, each clip identifier comprising the starting point and the stopping point for a corresponding clip, activation of one of the plurality of clip identifiers causing transmittal of a stream of data from the memory system corresponding to the corresponding clip so that the corresponding clip is presentable via the media program;
storing the plurality of clip identifiers on the memory system; and
listing the plurality of clip identifiers on the list.

25. The method of claim 20, further comprising
creating at least one composite clip identifier of the user for a composite media presentation by the user grouping at least two of the plurality of clip identifiers and thereby associating the plurality of clip identifiers with the composite clip identifier, activation of the at least one composite clip identifier causing transmittal of a stream of data from the memory system corresponding to a presentation of the composite media presentation in which each of the plurality of clips is presented in series;
storing the at least one composite clip identifier on the memory system;
listing the at least one composite clip identifier on the list; and
permitting access to at least a portion of the list by another user so that the another user can activate at least one of the clip identifiers and the at least one composite clip identifier created by the user, causing transmittal of a stream of data to a computer of the another user from the memory system so that the corresponding clip or the corresponding composite presentation is presented via a media program stored on the computer of the another user.

26. A system for presenting media streams comprising:
a memory system having stored therein data of a plurality media presentations;
a communication network providing for communication between the memory system and at least one computer;
data for a user interface stored on the memory system, the interface comprising, an input mechanism to permit a user of the at least one computer to select from any of the plurality of media presentations and a clip identification system adapted to receive input regarding a starting point for at least one clip of the media presentation and input regarding a stopping point of the clip of the media presentation, the clip corresponding to a portion of the media presentation stream beginning at the starting point and ending at the stopping point; the clip identification system adapted to create a clip identifier for the clip comprising the starting point and the stopping point, activation of the clip identifier by the user causing the computer to receive a stream of data from the memory system corresponding to the clip.
